(19) United States
(12) Patent Application Publication
(10) Pub. No.: US 2015/0022422 A1
(43) Pub. Date: Jan. 22, 2015

(54) MOBILE DEVICE AND MULTI-BAND ANTENNA STRUCTURE THEREIN

(71) Applicant: Acer Incorporated, New Taipei City (TW)

(72) Inventors: Kun-Sheng Chang, New Taipei City (TW); Ming-Yu Chou, New Taipei City (TW); Ching-Chi Lin, New Taipei City (TW)

(73) Assignee: Acer Incorporated, New Taipei City (TW)

(21) Appl. No.: 14/083,997

(22) Filed: Nov. 19, 2013

(30) Foreign Application Priority Data
Jul. 22, 2013 (TW) 102126052

(51) Int. Cl. H01Q 1/50

(52) U.S. Cl. CPC H01Q 1/50
USPC 343/861

(57) ABSTRACT

A mobile device includes a dielectric substrate, a ground plane, an RF (Radio Frequency) module, an antenna structure, a bypass inductor, matching circuits, and a switch circuit. The antenna structure includes a first radiation element and a second radiation element. The first end of the first radiation element is connected to the RF module, and the second end of the first radiation element is open. The second radiation element is separate from the first radiation element. The first end of the second radiation element is open and adjacent to the first radiation element, and the second end of the second radiation element is connected through the bypass inductor to the ground plane. The switch circuit selects one of the matching circuits according to a control signal. The second end of the second radiation element is further connected through the selected matching circuit to the ground plane.

### CROSS REFERENCE TO RELATED APPLICATIONS

This Application claims priority of Taiwan Patent Application No. 102126052 filed on Jul. 22, 2013, the entirety of which is incorporated by reference herein.

### BACKGROUND OF THE INVENTION

1. Field of the Invention

The disclosure generally relates to a mobile device, and more particularly to a mobile device comprising a multi-band antenna structure.

2. Description of the Related Art

With the progress of mobile communication technology, portable electronic devices, for example, portable computers, mobile phones, tablet computers, multimedia players, and other hybrid functional mobile devices, have become more common To satisfy user demand, portable electronic devices can usually perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

In the prior art, a metal element of a fixed size is often configured as the antenna body of a mobile device, and the length of the metal element should be equal to a half or a quarter of the wavelength of the desired band. As a result, the conventional antenna design is generally configured to cover a single band, rather than multiple bands.

### BRIEF SUMMARY OF THE INVENTION

To improve the aforementioned limited designs, in one exemplary embodiment, the disclosure is directed to a mobile device, comprising: a dielectric substrate; a ground plane, disposed on the dielectric substrate, wherein the dielectric substrate further has a clearance region; an RF (Radio Frequency) module; an antenna structure, disposed inside the clearance region, wherein the antenna structure comprises a first radiation element and a second radiation element, a first end of the first radiation element is connected to the RF module, a second end of the first radiation element is open, the second radiation element is separate from the first radiation element, and a first end of the second radiation element is open and adjacent to the first radiation element; a bypass inductor, wherein a second end of the second radiation element is connected through the bypass inductor to the ground plane; a plurality of matching circuits, having different impedance matching values; and a switch circuit, selecting one of the matching circuits according to a control signal, wherein the second end of the second radiation element is further connected through the selected matching circuit to the ground plane such that the antenna structure is capable of operating in multiple bands.

### BRIEF DESCRIPTION OF DRAWINGS

The invention can be more fully understood by reading the subsequent detailed description and examples with references made to the accompanying drawings, wherein:

FIG. 1 is a diagram for illustrating a mobile device according to an embodiment of the invention;

FIG. 2 is a diagram for illustrating a mobile device according to an embodiment of the invention;

FIG. 3 is a diagram for illustrating a mobile device according to an embodiment of the invention;

FIG. 4 is a diagram for illustrating a mobile device according to an embodiment of the invention;

FIG. 5 is a diagram for illustrating a VSWR (Voltage Standing Wave Ratio) of an antenna structure of a mobile device according to an embodiment of the invention; and

FIG. 6 is a diagram for illustrating antenna efficiency of an antenna structure of a mobile device according to an embodiment of the invention.

### DETAILED DESCRIPTION OF THE INVENTION

In order to illustrate the purposes, features and advantages of the invention, the embodiments and figures thereof in the invention are shown in detail as follows.

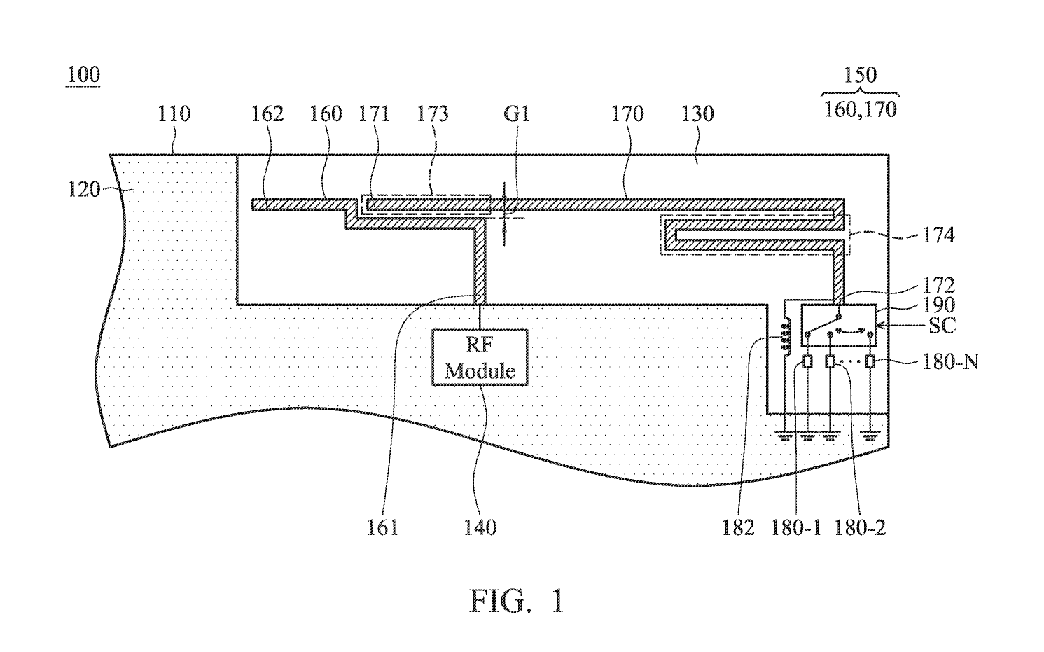

FIG. 1 is a diagram for illustrating a mobile device 100 according to an embodiment of the invention. The mobile device 100 may be a smartphone, a tablet computer, or a notebook computer. As shown in FIG. 1, the mobile device 100 at least comprises a dielectric substrate 110, a ground plane 120, an RF (Radio Frequency) module 140, an antenna structure 150, a plurality of matching circuits 180-1, 180-2, . . . , and 180-N (N is a positive integer which is greater than or equal to 2, such as 2, 3, 4, 5, or 6), a bypass inductor 182, and a switch circuit 190. The dielectric substrate 110 may be a system circuit board or an FR4 (Flame Retardant 4) substrate. The ground plane 120 and the antenna structure 150 may be made of metal, such as silver, copper, aluminum, or iron. The antenna structure 150 is substantially planar and disposed on the dielectric substrate 110. The RF module 140 is configured as a signal source for exciting the antenna structure 150. Note that the mobile device 100 may further comprise other components, such as a processor, a touch panel, a touch control module, a speaker, a battery, and a housing (not shown).

The ground plane 120 is disposed on the dielectric substrate 110. The dielectric substrate 110 further has a clearance region 130. In some embodiments, the clearance region 130 is adjacent to a corner of the dielectric substrate 110, and the clearance region 130 substantially has an L-shape or a rectangular shape. The antenna structure 150 is disposed inside the clearance region 130. The antenna structure 150 comprises a first radiation element 160 and a second radiation element 170. A first end 161 of the first radiation element 160 is connected to the RF module 140, and a second end 162 of the first radiation element 160 is open. In some embodiments, the mobile device 100 may further comprise a feeding matching circuit (not shown) which comprises one or more capacitors and/or inductors, such as chip capacitors and/or chip inductors. The feeding matching circuit is connected between the RF module 140 and the first end 161 of the first radiation element 160, and is configured to adjust the impedance matching of the antenna structure 150. The second radiation element 170 is separate from the first radiation element 160, and the mutual coupling effect is induced between the second radiation element 170 and the first radiation element 160. A first end 171 of the second radiation element 170 is open and adjacent to the first radiation element 160, and a second end 172 of the second radiation element 170 is connected through the bypass inductor 182 to the ground plane 120. More particularly, the second radiation element 170 comprises a coupling portion 173, and the coupling portion 173 comprises the first end 171 of the second radiation element 170. A coupling gap G1 is formed between the coupling portion 173 and the first radiation element 160. In some embodiments, a length of the coupling portion 173 is greater than 2 mm, and a width of the coupling gap G1 is smaller than 2 mm. The second radiation element 170 may further comprise a meandering portion 174. In some embodiments, the meandering portion 174 substantially has a U-shape. In other embodiments, the meandering portion 174 comprises a combination of a plurality of U-shaped portions connected to each other. Note that the shapes of the first radiation element 160 and the second radiation element 170 are not limited in the invention. For example, any of the first radiation element 160 and the second radiation element 170 may substantially have a straight-line shape, a U-shape, an L-shape, an S-shape, an M-shape, or a V-shape. In some embodiments, the length of each of the first radiation element 160 and the second radiation element 170 is equal to 0.25 wavelength (λ/4) of a central frequency of the antenna structure 150.

Each of the matching circuits 180-1, 180-2, . . . , and 180-N may comprise one or more capacitors and/or inductors, such as chip capacitors and/or chip inductors. The matching circuits 180-1, 180-2, . . . , and 180-N may have different impedance matching values. The switch circuit 190 can select one of the matching circuits 180-1, 180-2, . . . , and 180-N according to a control signal SC. In some embodiments, the control signal SC is generated by a processor (not shown), or is generated according to a signal input by the user. The second end 172 of the second radiation element 170 is further connected through the selected matching circuit to the ground plane 120. Since the matching circuits 180-1, 180-2, . . . , and 180-N provide different effective resonant lengths for the antenna structure 150, the antenna structure 150 is capable of operating in multiple bands. The bypass inductor 182 is configured to prevent the switch circuit 190 from negatively affecting the radiation efficiency of the antenna structure 150. In some embodiments, an inductance of the bypass inductor 182 is substantially from 5 nH to 10 nH.

The antenna structure 150 of the invention is substantially planar. The antenna structure 150 and other electronic circuit components may be formed directly on a system mother board (i.e., the dielectric substrate 110) using the PCB (Printed Circuit Board) process and the SMT (Surface Mount Technology) process. Accordingly, no extra cost for manufacturing the antenna structure is generated, and no extra space for accommodating the antenna structure is required. By appropriately switching between the matching circuits 180-1, 180-2, . . . , and 180-N, the antenna structure 150 of the invention can cover multiple bands without changing its total size. To be brief, the invention at least has the advantage of reducing cost, saving space, and increasing antenna bandwidth, such that it is suitably applied to a variety of small-size mobile devices.

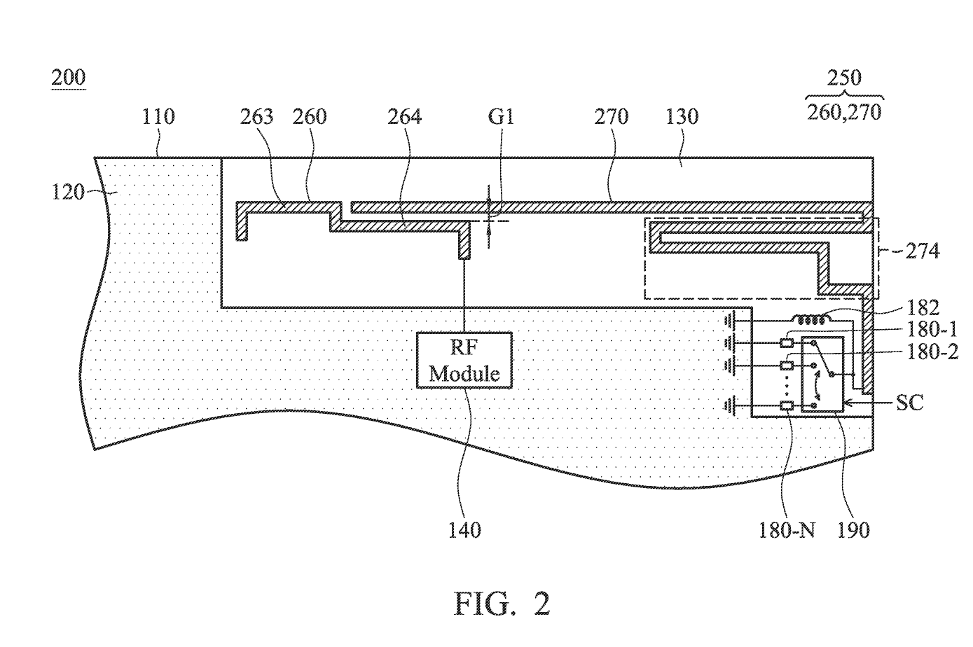

FIG. 2 is a diagram for illustrating a mobile device 200 according to an embodiment of the invention. FIG. 2 is similar to FIG. 1. In the embodiment of FIG. 2, a first radiation element 260 of an antenna structure 250 comprises a U-shaped portion 263 and an L-shaped portion 264 that are connected to each other, and a meandering portion 274 of a second radiation element 270 of the antenna structure 250 comprises a U-shaped portion and an N-shaped portion that are connected to each other. The shapes of the first radiation element 260 and the second radiation element 270 may be adjusted according to different desires to further reduce the total size of the antenna structure 250. Other features of the mobile device 200 of FIG. 2 are similar to those of the mobile device 100 of FIG. 1. Accordingly, the two embodiments can achieve similar performances.

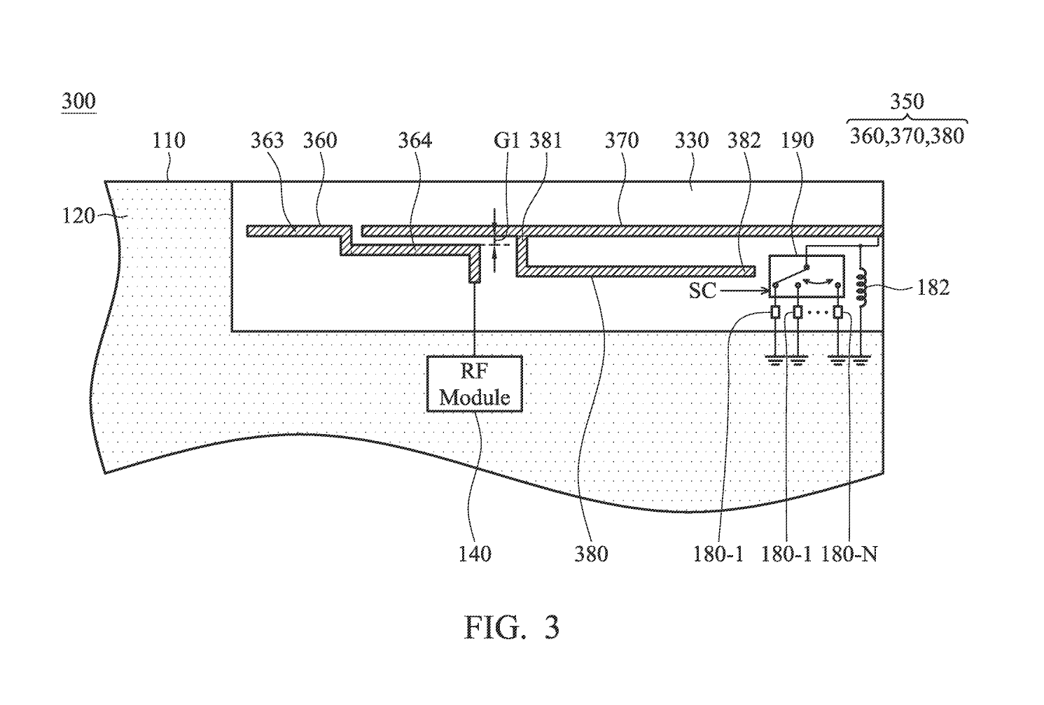

FIG. 3 is a diagram for illustrating a mobile device 300 according to an embodiment of the invention. FIG. 3 is similar to FIG. 1. In the embodiment of FIG. 3, a first radiation element 360 of an antenna structure 350 comprises a first L-shaped portion 363 and a second L-shaped portion 364 that are connected to each other. In addition, a second radiation element 370 of the antenna structure 350 substantially has a straight-line shape, and the antenna structure 350 further comprises a third radiation element 380. The third radiation element 380 substantially has an L-shape. A first end 381 of the third radiation element 380 is connected to the second radiation element 370, and a second end 382 of the third radiation element 380 is open and adjacent to the switch circuit 190. In comparison to FIG. 1, the second radiation element 370 shown in FIG. 3 does not comprise any meandering portion, and the third radiation element 380 is further incorporated into the antenna structure 350, such that the resultant resonance will be shifted to higher frequency due to removal of the meandering portion. In such a design, the total size of the antenna structure 350 is further reduced, and the switch circuit 190 and the antenna structure 350 can both be disposed within a clearance region 330 of the dielectric substrate 110. The clearance region 330 substantially has a rectangular shape, and its size is smaller than that of the clearance region 130 of FIG. 1. As mentioned above, the shapes of the first radiation element 360 and the second radiation element 370 may be adjusted according to different desires. Other features of the mobile device 300 of FIG. 3 are similar to those of the mobile device 100 of FIG. 1. Accordingly, the two embodiments can achieve similar performances.

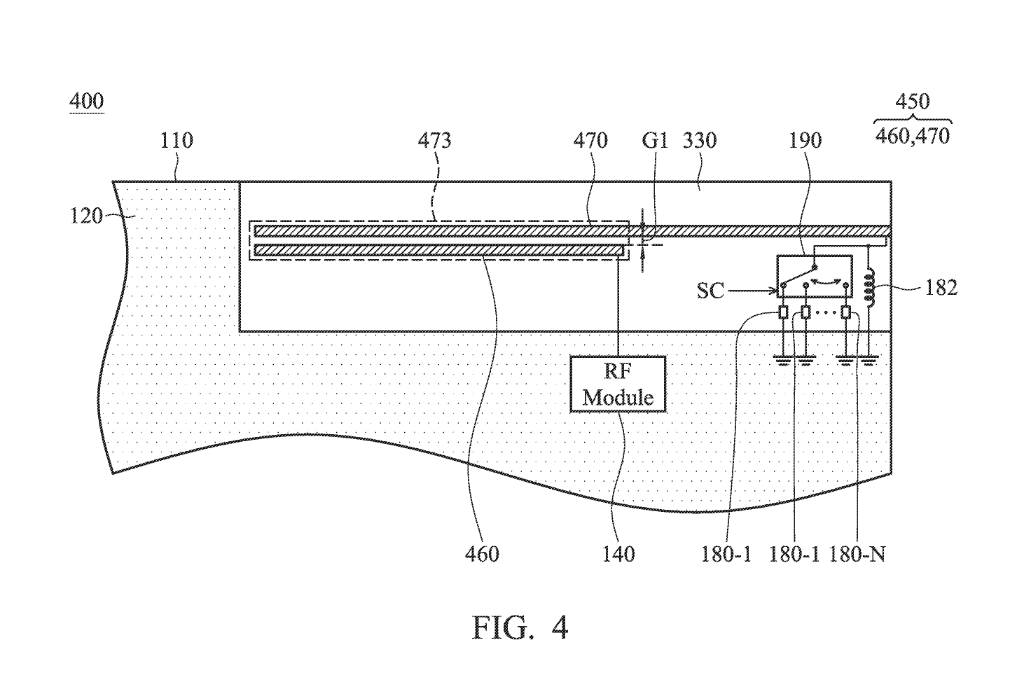

FIG. 4 is a diagram for illustrating a mobile device 400 according to an embodiment of the invention. FIG. 4 is similar to FIG. 1. In the embodiment of FIG. 4, a first radiation element 460 of an antenna structure 450 substantially has a straight-line shape, and a second radiation element 470 of the antenna structure 450 also substantially has a straight-line shape. A length of the second radiation element 470 is greater than a length of the first radiation element 460. In comparison to FIG. 1, the first radiation element 460 and the second radiation element 470 shown in FIG. 4 do not comprise any meandering portion, and a length of a coupling portion 473 of the second radiation element 470 is apparently increased, such that the resultant resonance will be shifted to higher frequency due to removal of the meandering portion. In such a design, the total size of the antenna structure 450 is further reduced, and the switch circuit 190 and the antenna structure 450 can both be disposed within a clearance region 330 of the dielectric substrate 110. The clearance region 330 substantially has a rectangular shape, and its size is smaller than that of the clearance region 130 shown in FIG. 1. As mentioned above, the shapes of the first radiation element 460 and the second radiation element 470 may be adjusted according to different desires. Other features of the mobile device 400 of FIG. 4 are similar to those of the mobile device 100 of FIG. 1. Accordingly, the two embodiments can achieve similar performances.

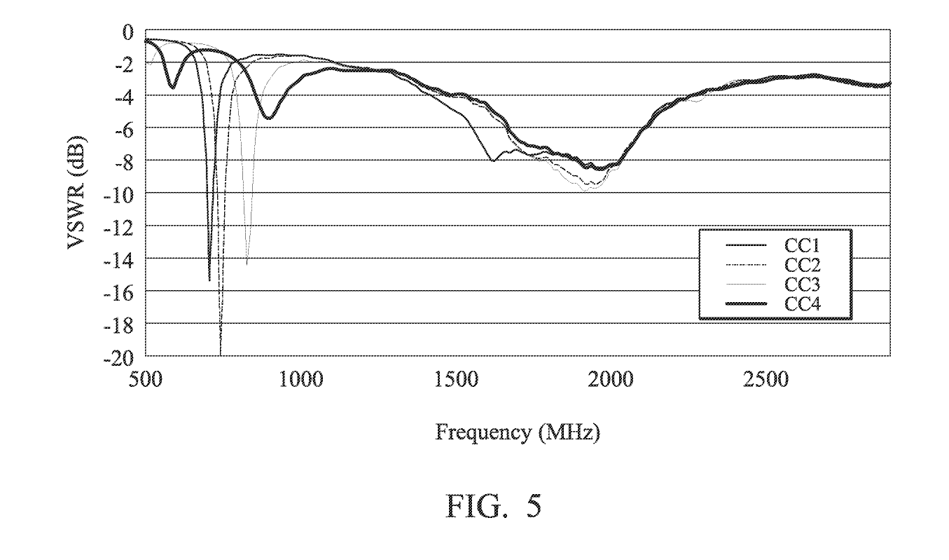

FIG. 5 is a diagram for illustrating a VSWR (Voltage Standing Wave Ratio) of the antenna structure 150 of the mobile device 100 according to an embodiment of the invention. The horizontal axis represents operation frequency (MHz), and the vertical axis represents the VSWR. In the embodiment of FIG. 5, the number of the matching circuits 180-1, 180-2, . . . , and 180-N is 4 (i.e., N=4), and the antenna structure 150 selectively operates in a first band, a second band, a third band, or a fourth band. More particularly, when the switch circuit 190 selects a first matching circuit, the curve CC1 shows the return loss versus the operation frequency of the antenna structure 150 which covers the first band; when the switch circuit 190 selects a second matching circuit, the curve CC2 shows the return loss versus the operation frequency of the antenna structure 150 which covers the second band; when the switch circuit 190 selects a third matching circuit, the curve CC3 shows the return loss versus the operation frequency of the antenna structure 150 which covers the third band; and when the switch circuit 190 selects a fourth matching circuit, the curve CC4 shows the return loss versus the operation frequency of the antenna structure 150 which covers the fourth band. In a preferred embodiment, the first band is substantially from 704 MHz to 746 MHz, the second band is substantially from 746 MHz to 787 MHz, the third band is substantially from 824 MHz to 894 MHz, and the fourth band is substantially from 880 MHz to 960 MHz. In some embodiments, in addition to a low band from 704 MHz to 960 MHz, the antenna structure 150 can further cover a high band from 1710 MHz to 2170 MHz (no matter which matching circuit is selected). The low band is generated by a first resonant path which comprises the first radiation element 160, the second radiation element 170, and the selected matching circuit. The high band is generated by a second resonant path which comprises the first radiation element 160. Accordingly, the antenna structure of the invention can at least cover multiple bands of LTE (Long Term Evolution) Band 17, LTE Band 13, WCDMA (Wideband Code Division Multiple Access) Band 8, and WCDMA Band 5 in such a manner that the LTE/WWAN (Long Term Evolution/Wireless Wide Area Network) multi-band operation is achieved.

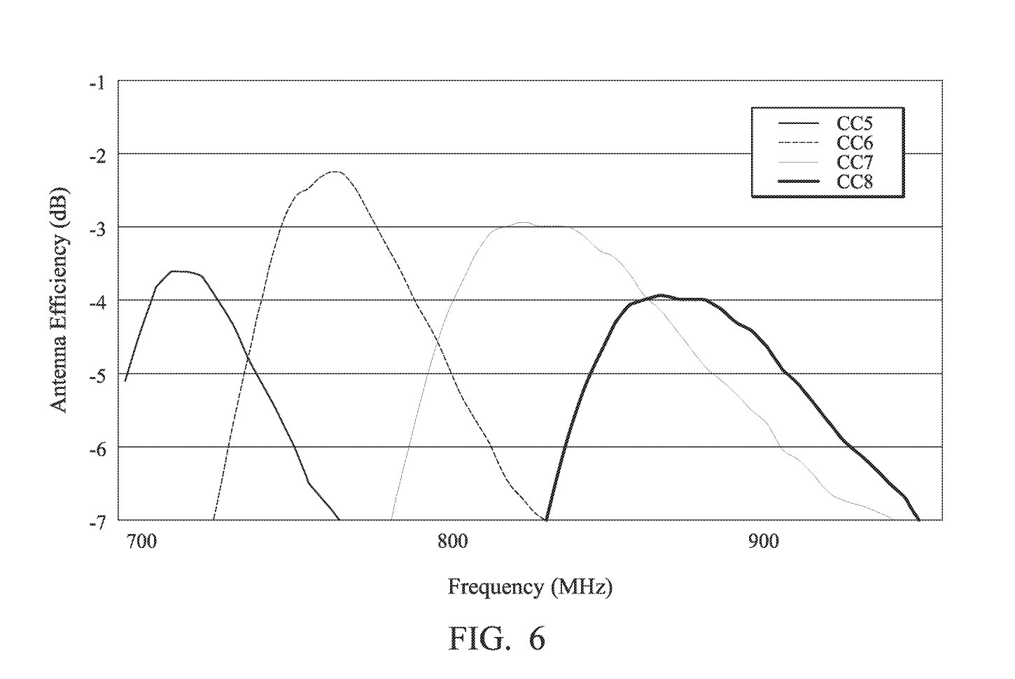

FIG. 6 is a diagram for illustrating antenna efficiency of the antenna structure 150 of the mobile device 100 according to an embodiment of the invention. The horizontal axis represents operation frequency (MHz), and the vertical axis represents the antenna efficiency (dB). Please refer to FIG. 5 and FIG. 6 together. In the embodiment of FIG. 6, the curve CC5 shows the antenna efficiency versus the operation frequency of the antenna structure 150 which operates in the first band; the curve CC6 shows the antenna efficiency versus the operation frequency of the antenna structure 150 which operates in the second band; the curve CC7 shows the antenna efficiency versus the operation frequency of the antenna structure 150 which operates in the third band; and the curve CC8 shows the antenna efficiency versus the operation frequency of the antenna structure 150 which operates in the fourth band. As shown in FIG. 6, the antenna efficiency of the antenna structure 150 is greater than −4 dB in all of the first band, the second band, the third band, and the fourth band, and it meets the requirement of practical applications.

Note that the aforementioned element sizes, element parameters, element shapes, and frequency ranges are not limitations of the invention. An antenna engineer can adjust these settings according to different requirements. In addition, the mobile device and the antenna structure of the invention are not limited to the configurations of FIGS. 1-4. The invention may merely include any one or more features of any one or more embodiments of FIGS. 1-4. In other words, not all of the features shown in the figures should be implemented in the mobile device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a dielectric substrate;
a ground plane, disposed on the dielectric substrate, wherein the dielectric substrate further has a clearance region;
an RF (Radio Frequency) module;
an antenna structure, disposed inside the clearance region, wherein the antenna structure comprises a first radiation element and a second radiation element, a first end of the first radiation element is connected to the RF module, a second end of the first radiation element is open, the second radiation element is separate from the first radiation element, and a first end of the second radiation element is open and adjacent to the first radiation element;
a bypass inductor, wherein a second end of the second radiation element is connected through the bypass inductor to the ground plane;
a plurality of matching circuits, having different impedance matching values; and
a switch circuit, selecting one of the matching circuits according to a control signal, wherein the second end of the second radiation element is further connected through the selected matching circuit to the ground plane such that the antenna structure is capable of operating in multiple bands.

2. The mobile device as claimed in claim 1, wherein the clearance region is adjacent to a corner of the dielectric substrate, and the clearance region substantially has an L-shape or a rectangular shape.

3. The mobile device as claimed in claim 1, wherein an inductance of the bypass inductor is substantially from 5 nH to 10 nH.

4. The mobile device as claimed in claim 1, wherein the second radiation element comprises a coupling portion, the coupling portion comprises the first end of the second radiation element, and a coupling gap is formed between the coupling portion and the first radiation element.

5. The mobile device as claimed in claim 1, wherein the first radiation element comprises a U-shaped portion and an L-shaped portion, and the U-shaped portion and the L-shaped portion are connected to each other.

6. The mobile device as claimed in claim 1, wherein the first radiation element comprises a first L-shaped portion and a second L-shaped portion, and the first L-shaped portion and the second L-shaped portion are connected to each other.

7. The mobile device as claimed in claim 1, wherein the antenna structure further comprises a third radiation element, a first end of the third radiation element is connected to the second radiation element, and a second end of the third radiation element is open and adjacent to the switch circuit.

8. The mobile device as claimed in claim 1, wherein the first radiation element substantially has a straight-line shape.

9. The mobile device as claimed in claim 1, wherein the second radiation element substantially has a straight-line shape, and a length of the second radiation element is greater than a length of the first radiation element.

10. The mobile device as claimed in claim 1, wherein the number of the matching circuits is 4, and the antenna structure selectively operates in a first band, a second band, a third band, or a fourth band, wherein the first band is substantially from 704 MHz to 746 MHz, the second band is substantially from 746 MHz to 787 MHz, the third band is substantially from 824 MHz to 894 MHz, and the fourth band is substantially from 880 MHz to 960 MHz.
